(19) United States
(12) Patent Application Publication
(10) Pub. No.: US 2006/0231569 A1
(43) Pub. Date: Oct. 19, 2006

(54) Technique and device for proportioning of beverages while they flow

(76) Inventor: Stayko Penev Ivanov, Plovdiv (BG)

Correspondence Address: D Peter Hochberg;The Baker Building-6th Floor, 1940 East 6th Street, Cleveland, OH, 44114-2294, US

(21) Appl. No.: 10/545,525

(22) PCT Filed: Feb. 14, 2003
(86) PCT No.: PCT/IB03/00509

§ 371 Date: Aug. 15, 2005

(51) Int. Cl. B67D 5/08

(52) U.S. Cl. 222/60

(57) ABSTRACT

A device and technique for proportioning of beverages while they flow which employ the working of gravity on a cyclic basis. The technique is based on a driving wheel's rotation initiated by an outflow of liquid. For the duration of a single cycle of proportioning, a set amount of beverage is allowed to flow out, which is in a direct ratio to the continuance of a proportioning cycle as completed by the driving wheel and in a reverse ratio to the rate of rotation. The rate of rotation is being set by the degree of inclination of the driving wheel's blades. The higher the blades' degree of inclination, the higher the driving wheel's rate of rotation is; this results in a smaller amount of liquid allowed to flow out (i.e. be proportioned) for the duration of a single cycle, and vice versa.

### CROSS-REFERENCE TO RELATED APPLICATION

This application is a National Stage application of International Application No. PCT/IB2003/000509, filed on Feb. 14, 2003.

### BACKGROUND OF THE INVENTION

1. Field of the Invention

The invention concerns a technique and device for proportioning of beverages while they flow with application in restaurants, cafes and other drinking places.

2. Description of the Prior Art

The technique for proportioning of beverages by using a measuring unit has been known for quite a time now. It involves a special dosing bowl which can contain a specified amount of beverage as measured by the horizontal level being reached. There also exist fixed proportioning devices which involve a bottom-up bottle and employ a volumetric technique for measurement.

### SUMMARY OF THE INVENTION

The present invention is intended to facilitate and perfect proportioning of drinks. That goal has been achieved by implementing a technique and a device shown at the enclosed figures, where a proportioning tool should be fastened firmly at the top of a bottle, and a bottle cap should be screwed on it. With the bottle being set bottom-up, some liquid flows into the device through an inlet, and a proportionate amount of air flows into the bottle by a separate opening. Both amounts balance each other, thus preserving constant pressure inside the bottle. The amount of liquid outflow is also kept constant, together with the internal pressure, regardless of liquid quantity in the bottle.

An inflow of liquid sets a driving wheel in motion by applying its mechanical energy. The driving wheel completes a single cycle of rotation, for the duration of which an amount of liquid flows out as allowed by the rate of rotation. For its part, that rate is being set by the degree of inclination of driving wheel's blades. At the end of a proportioning cycle, the driving wheel shuts an outlet, thus preventing further outflow of liquid through the device.

With the bottle being set up straight again, the driving wheel returns to a starting position for a new cycle, thus also preventing the bottle from being filled up through the device. When screwed on tight, the bottle cap shuts the air opening along with the outlet.

The technique is based on a direct ratio existing between the amount of liquid outflow and the duration of a single cycle as completed by the driving wheel. There exists a reverse ratio between the amount of liquid outflow and the duration of a proportioning cycle as completed by the driving wheel. The rate at which the driving wheel rotates is being set by the degree of inclination of the wing-shaped blades along its outer edge. The higher the blades' degree of inclination, the higher the driving wheel's rate of rotation is for the duration of a proportioning cycle. As a result, the amount of liquid outflow decreases. When the blades feature lower degree of inclination, the driving wheel's rotation respectively decelerates, which results in a larger amount of liquid outflow.

With the device containing an inlet smaller than an outlet, the driving wheel employs the kinetic energy of a liquid and its blades' longitudinal section is uniform. As a result, inertial force is being triggered by alteration of velocity direction of the liquid which is flowing through the driving wheel.

Another example of specific implementation is a device which for the most part employs the potential energy of liquid inflow. In such a case, the inlet represents a steering mechanism which features convergent blades, as also does the driving wheel. With outflow and pressure being kept as constant parameters, the liquid's force, which sets the driving wheel in motion, remains constant as well. Such a model employs the potential energy alone of a liquid inside a bottle.

### BRIEF DESCRIPTION OF THE DRAWINGS

FIG. 1—General View

FIG. 2—Longitudinal Section

FIG. 3—An Example of Implementation with a Loose Motion Mechanism

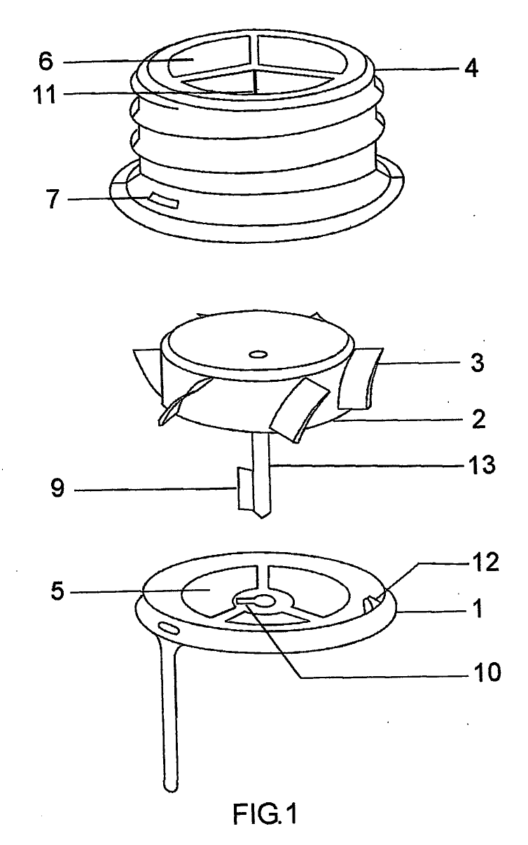

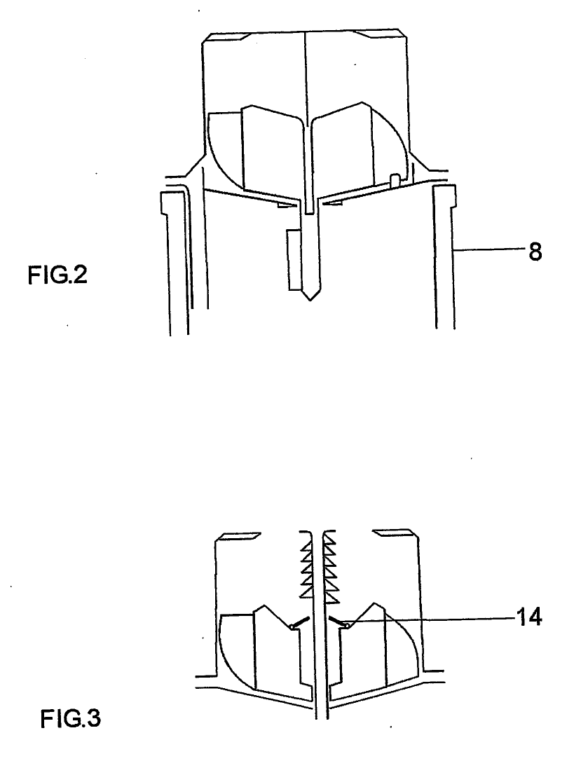

### DETAILED DESCRIPTION OF THE INVENTION

The device is composed of a base (1) and body (4) which combine to form an opening (7) allowing free flow of air in the bottle (8). The base (1) also serves as an inlet (5) and the body as an outlet (6), which can be shaped like steering mechanisms when employing any form of kinetic or potential energy of an outflow of liquid. In between these, on the axes (11)-(13), revolves a driving wheel (2) furnished with wing-shaped blades (3). The degree of inclination of the blades sets the rate at which the driving wheel (2) rotates for the duration of a single cycle. The cycle ends with the insertion of the tooth (9) in the channel (10), which allows the driving wheel to shut the outlet (6). With the bottle (8) being set up straight, the tooth (9) and channel (10) direct the driving wheel (2) to an initial position, while the cog (12) turns it by a minimal degree so as to take a starting position for another cycle. In such a position the driving wheel (2) shuts the inlet (5) as well, thus preventing the bottle from being filled up through the device. When screwed on tight, the bottle cap shuts the air opening (7) along with the outlet (6).

Another example of specific implementation is shown in FIG. 3 where the axis (11) is shaped like a screw. The driving wheel (2) should be fastened on that screw so as to shut the outlet (6). With the bottle being set up straight, the driving wheel (2) returns to its initial position owing to the loose motion mechanism (14).

The device can be made of plastic. The base (1) and body (4) are compliant with the relevant standards. The driving wheel can be changed with respect to its blades' degree of inclination in order to set a different amount of beverage to be proportioned, when this is necessary because of various kinds of drinks, cultural traditions or local preferences.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

1. A technique for proportioning of beverages while the beverages flow which employs the working of gravity on a cyclic basis and maintains a direct ratio between the duration of a single cycle on the part of a driving wheel and the amount of liquid outflow being proportioned, and maintains a reverse ratio between the rate of rotation of said driving wheel and the amount of liquid outflow being proportioned, and wherein said technique further includes said driving wheel being a freely fixed driving wheel that performs a positional (gradual) movement during the stages of a proportioning cycle for whose duration are being kept as constant inrush, pressure and amount of liquid outflow.

2. A device for proportioning of beverages while the beverages flow which employs the working of gravity on a cyclic basis, comprising a chamber having a driving wheel and containing a bottle having a separate opening, wherein said chamber prevents air from flowing inside the bottle by featuring the separate opening, wherein the mechanical energy of liquid flowing through the device causes said driving wheel to complete a cycle of rotation and then prevent further outflow of liquid through the device, and wherein said driving wheel makes axial progressive and reflex rotation for the duration of a proportioning cycle.

3. The device for proportioning of beverages while the beverages flow according to claim 2, said device further comprising an inlet and an outlet, wherein said inlet is smaller than said outlet, and wherein said driving wheel employs the kinetic energy of a liquid.

4. The device for proportioning of beverages while the beverages flow according to claim 3, wherein said driving wheel employs the potential energy of a liquid located between said inlet and said outlet.

5. The device for proportioning of beverages while the beverages flow according to claim 4, wherein said driving wheel has an axis of rotation, said device further comprising an air opening located inside said axis of rotation of said driving wheel.

6. device for proportioning of beverages while the beverages flow according to claim 5, wherein said driving wheel has a tangential axis and the bottle contained in said chamber has a longitudinal axis, and wherein said driving wheel makes a rotation around said tangential axis and another rotation around the longitudinal axis of the bottle.

7. The device for proportioning of beverages while the beverages flow according to claim 6, wherein said driving wheel shuts said outlet.

8. The device for proportioning of beverages while the beverages flow according to claim 7, wherein said driving wheel shuts said inlet.

9. The device for proportioning of beverages while the beverages flow according to claim 8, wherein said driving wheel makes a single revolution for the duration of a proportioning cycle.

10. The device for proportioning of beverages while the beverages flow according to claim 9, wherein said driving wheel makes less than a single revolution for the duration of a proportioning cycle.

11. The device for proportioning of beverages while the beverages flow according to claim 10, wherein said driving wheel makes more than a single revolution for the duration of a proportioning cycle owing to a loose motion mechanism.

12. The device for proportioning of beverages while the beverages flow according to claim 10, further comprising a tooth having a motion and a surface that services said motion of said tooth, said surface being implemented at an angle.

13. The device for proportioning of beverages while the beverages flow according to claim 12, wherein said driving wheel comprises wing-shaped blades.

14. The device for proportioning of beverages while the beverages flow according to claim 13, wherein said driving wheel comprises screw-shaped blades.

15. The device for proportioning of beverages while the beverages flow according to claim 14, wherein said blades of said driving wheel have a variable radial degree of inclination.

16. The technique for proportioning of beverages while the beverages flow according to claim 1, wherein said driving wheel makes a tri-positional motion.

17. The technique for proportioning of beverages while the beverages flow according to claim 16, wherein said driving wheel makes a bi-positional motion.
